(19) United States
(12) Patent Application Publication
(10) Pub. No.: US 2018/0064242 A1
(43) Pub. Date: Mar. 8, 2018

(54) Banquet Table with Reinforced Blow-Molded Table Top

(71) Applicant: Frank Tsai, Shenzhen (CN)

(72) Inventor: Frank Tsai, Shenzhen (CN)

(21) Appl. No.: 15/259,036

(22) Filed: Sep. 7, 2016

(51) Int. Cl. A47B 13/08; A47B 3/08; A47B 3/091; B29C 45/14

(52) U.S. Cl. CPC A47B 13/083; A47B 13/08; A47B 3/08; B29L 2031/448; B29C 45/14598; B29C 45/14336; A47B 3/0912

(57) ABSTRACT

A banquet table includes a reinforcing tabletop frame and a supporting frame. The reinforcing tabletop frame includes a reinforcing tabletop panel, which is made of mold-injected material, having two surrounding rims extended along two longitudinal sides of the reinforcing tabletop panel respectively, and a plurality of reinforcing arrangements spacedly embedded in the surrounding rims of the reinforcing tabletop panel respectively. The supporting frame includes two runners attached along the surrounding rims of the reinforcing tabletop panel via the reinforcing arrangements, and two leg frame pivotally attached at a bottom side of the reinforcing tabletop panel.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a banquet table, and more particularly to a foldable table with a reinforced blow-molded tabletop which comprises a plurality of reinforcing arrangement to ensure a connection between the tabletop and other components.

### Description of Related Arts

A conventional foldable table generally comprises a tabletop panel and a supporting frame, wherein the supporting frame comprises a table top reinforcing frame having two runners and a leg frame connected thereunder in a pivotally foldable manner. Since the conventional tabletop is usually made of lightweight and plastic material in order to enhance the portability of the foldable table, the two runners of the tabletop reinforcing frame are spacedly mounted along two longitudinal sides of the peripheral edge rim of the tabletop panel to ensure the strength of the tabletop panel. Based on the common technology, the runners are directly fastened on the peripheral edge rim of the tabletop by fasteners, and in such a manner the fasteners are passed through the peripheral edge rim, so the thickness of the peripheral edge rim requires being thick enough to support the fasteners mounted thereon. However, this kinds of foldable table has several drawbacks:

Since the tabletop is usually manufactured by mold injection, the thickness of the whole tabletop is unique. In order to reduce the manufacturing cost, the thickness of the whole tabletop is required to be minimized. But, if the thickness of the whole tabletop is minimized, the runners cannot be securely mounted on the peripheral edge rim of the tabletop, and the tabletop is easy to be deformed by external force. In other words, if the thickness of the whole tabletop is increased to ensure the runners being mounted on the peripheral edge rim of the tabletop, the manufacturing costs thereof is dramatically increased, and the manufacturing process thereof also become more complicated. Furthermore, the fasteners are directly fastened on the runners and tabletop by external forces, and the external forces are distributed on an overall area of the tabletop, so cracks are easily to be generated on the tabletop or runners after the fasteners are fastened thereon. In other words, the fasteners are easily to be detached from the tabletop, and then the runners will detach from the tabletop, so the tabletop cannot be completely protected by the runners.

Moreover, other components, such as leg holder or battery components are able to be mounted on the tabletop. And, the components are mounted on the tabletop by the fasteners. Since the fasteners are passed through the components and the tabletop, the external forces are exerted on the components and tabletop directly, and then the structure of the components may be destroyed, so as to affect the usage of the components.

### SUMMARY OF THE PRESENT INVENTION

The invention is advantageous in that it provides a banquet table which comprises a plurality of reinforcing arrangements embedded in different predetermined locations of a reinforcing tabletop panel to attach two runners and/or other components on the reinforcing tabletop panel.

Another advantage of the invention is to provide a banquet table, wherein the reinforcing arrangements are pre-installed and built-in with the reinforcing tabletop panel to form the reinforcing tabletop frame, such that the reinforcing tabletop frame can be incorporated with different types of supporting frame to form the banquet table.

Another advantage of the invention is to provide a banquet table, wherein each of the reinforcing arrangements comprises a reinforcing sleeve embedded in the surrounding rim of the reinforcing tabletop panel, so as to increase an attachment area between the tabletop panel and the runner.

Another advantage of the invention is to provide a banquet table, wherein the reinforcing arrangements are embedded at the reinforcing tabletop panel during the mold injection process thereof, so as to securely retain the reinforcing arrangements at the desired locations to fasten with the runners.

Another advantage of the invention is to provide a banquet table, wherein each of the reinforcing sleeves has two ends and a fastener channel formed therebetween, such that a fastener is extended through the runner to engage with the fastener channel in order to couple the runner and the surrounding rim of the reinforcing tabletop panel.

Another advantage of the invention is to provide a banquet table, wherein two ends of the reinforcing sleeve are embedded in the inner and outer walls of the surrounding rim of the reinforcing tabletop panel to enhance the attachment strength of the runner to the surrounding rim.

Another advantage of the invention is to provide a banquet table, wherein the reinforcing arrangement comprises a fastener cavity integrally and transversely indented at the surrounding rim, such that the reinforcing disc is embedded in the fastener cavity.

Another advantage of the invention is to provide a banquet table, wherein the reinforcing arrangement enhances the connection between the runners and the surrounding rims of the reinforcing tabletop panel without increasing the thickness of the reinforcing tabletop panel, especially the thickness of the surrounding rim.

Another advantage of the invention is to provide a banquet table, wherein the manufacturing process of the banquet table is simplified to minimize the manufacturing cost of the banquet table incorporating with the reinforcing arrangement.

Another advantage of the invention is to provide a banquet table, which does not involve complicated and expensive mechanical components and processes so that the manufacturing cost of the present invention can be minimized.

Another advantage of the invention is to a banquet table, which does not require to alter the original structural design of the banquet table, so as to minimize the installation cost of the supporting frame incorporating with the reinforcing tabletop frame having the reinforcing arrangement.

Another advantage of the invention is to a banquet table, wherein no expensive or complicated structure is required to employ in the present invention in order to achieve the above mentioned objects. Therefore, the present invention successfully provides an economic and efficient solution for providing a simple and rigid configuration for the banquet table.

Additional advantages and features of the invention will become apparent from the description which follows, and may be realized by means of the instrumentalities and combinations particular point out in the appended claims.

According to the present invention, the foregoing and other objects and advantages are attained by a banquet table, comprising:

a reinforcing tabletop frame comprising a reinforcing tabletop panel, which is made of mold-injected material, having two surrounding rims extended along two longitudinal sides of the reinforcing tabletop panel respectively, and a plurality of reinforcing arrangements spacedly embedded in the surrounding rims of the reinforcing tabletop panel respectively; and

a supporting frame comprising two runners attached along the surrounding rims of the reinforcing tabletop panel via the reinforcing arrangements, and two leg frame pivotally attached at a bottom side of the reinforcing tabletop panel.

In accordance with another aspect of the invention, the present invention comprises a method for manufacturing a banquet table comprises the following steps.

(1) Manufacture a reinforcing tabletop frame by the steps of:

(1.1) mold-injecting a raw material in a tabletop mold to form a reinforcing tabletop panel having two surrounding rims extended along two longitudinal sides of the reinforcing tabletop panel respectively; and

(1.2) spacedly embedding a plurality of reinforcing arrangements in the surrounding rims of the reinforcing tabletop panel respectively during mold-injection process.

(2) Attach two runners along the surrounding rims of the reinforcing tabletop panel via the reinforcing arrangements

(3) Pivotally attach two leg frames at a bottom side of the reinforcing tabletop panel.

In accordance with another aspect of the invention, the present invention comprises reinforcing tabletop frame for a banquet table which comprises two runners and two leg frames, comprising:

a reinforcing tabletop panel, which is made of mold-injected material, having two surrounding rims extended along two longitudinal sides of the reinforcing tabletop panel respectively, wherein the reinforcing tabletop panel has a bottom side adapted for pivotally coupling with the leg frames; and

a plurality of reinforcing arrangements spacedly embedded in the surrounding rims of the reinforcing tabletop panel respectively for attaching the runners along the surrounding rims the reinforcing tabletop panel.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a banquet table according to a preferred embodiment of the present invention.

FIG. 2 is a perspective view of the reinforcing arrangement of the banquet table according to the above preferred embodiment of the present invention.

FIG. 3 is a sectional view of the reinforcing tabletop frame of the banquet table according to the above preferred embodiment of the present invention.

FIG. 4 illustrates a first alternative mode of the reinforcing arrangement of the banquet table according to the above preferred embodiment of the present invention.

FIG. 5 is a sectional view of the first alternative mode of the reinforcing tabletop frame of the banquet table according to the above preferred embodiment of the present invention.

FIG. 6 illustrates a second alternative mode of the reinforcing arrangement of the banquet table according to the above preferred embodiment of the present invention.

FIG. 7 illustrates a third alternative mode of the reinforcing arrangement of the banquet table according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

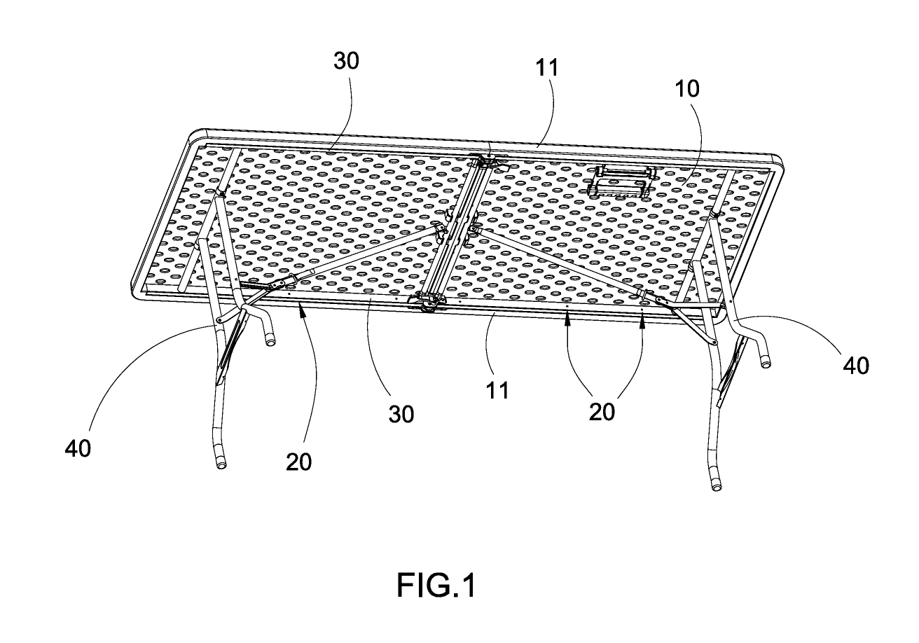

Referring to FIG. 1 of the drawings, a banquet table according to a preferred embodiment of the present invention is illustrated, wherein the banquet table, which is embodied as a foldable table, comprises a reinforcing tabletop frame and a supporting frame.

The reinforcing tabletop frame comprises a reinforcing tabletop panel 10 made of mold-injected material such as plastic, and a plurality of reinforcing arrangements 20. The reinforcing tabletop panel 10 is embodied as a blow-molded tabletop formed by mold injection process. In particular, the reinforcing tabletop panel 10 comprises two surrounding rims 11 downwardly extended along two longitudinal sides of the reinforcing tabletop panel 10 respectively. Preferably, each of the surrounding rims 11 has an inner wall 111, an outer wall 112 spaced apart with each other, and a bottom wall 113 extended between two bottom edges of the inner and outer walls 111, 112. Each of the surrounding rims 11 further has a plurality of fastening through holes 114 spacedly formed at the inner wall 111. The reinforcing arrangements 20 are spacedly embedded in the surrounding rims 11 of the reinforcing tabletop panel 10 respectively.

The supporting frame comprises two runners 30 attached along the surrounding rims 11 of the reinforcing tabletop panel 10 via the reinforcing arrangements 20, and two leg frame 40 pivotally attached at a bottom side of the reinforcing tabletop panel 10.

The runners 30 are two elongated members extended along two inner sides of the surrounding rims 11 of the reinforcing tabletop panel 10 at the bottom side thereof. In particular, the runners 30 are extended along the inner walls 111 of the surrounding rims 11 of the reinforcing tabletop panel 10. Accordingly, each of the runners 30 has a plurality of runner through slots 31 for being coupled with the reinforcing arrangements 20, wherein the runner through slots 31 are aligned with the fastening through holes 114 respectively when the runner 30 is extended along the surrounding rim 11.

The two leg frames 40 are foldably coupled at the bottom side of the reinforcing tabletop panel 10, wherein each of the leg frames 40 are pivotally coupled between the runners 30 to move between an unfolded position that the leg frame 40 is outwardly folded from the bottom side of the reinforcing tabletop panel 10 to perpendicularly extend therefrom, and a folded position that the leg frame 40 is inwardly folded to overlap and rest on the bottom side of the reinforcing tabletop panel 10.

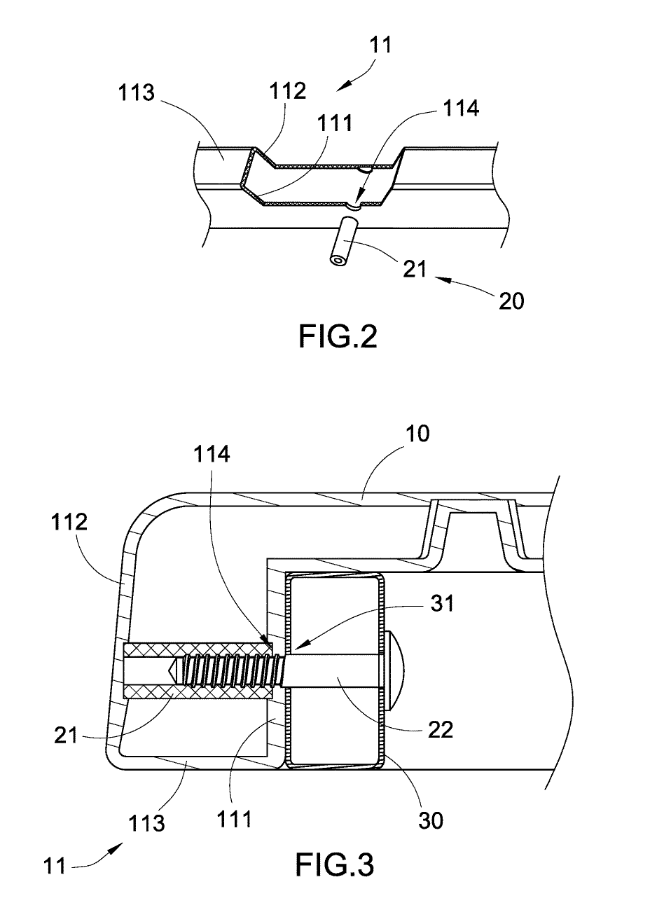

According to the preferred embodiment, each of the reinforcing arrangements 20 comprises a tubular reinforcing sleeve 21 embedded at the surrounding rim 11 of the reinforcing tabletop panel 10. Preferably, the reinforcing sleeve 21 is made of rigid material, such as metal, different from the reinforcing tabletop panel 10. The reinforcing sleeve 21 has two ends and a fastener channel formed therebetween. As shown in FIGS. 2 and 3, the two ends of the reinforcing sleeve 21 are embedded in two inner sides of the inner and outer walls 111, 112 of the surrounding rim 11, such that the reinforcing sleeve 21 is securely retained at the surrounding rim 11 between the inner and outer walls 111, 112 thereof. Therefore, the reinforcing sleeve 21 will not protruded from the inner wall 111 of the surrounding rim 11. It is worth mentioning that the reinforcing sleeve 21 can be coupled at the surrounding rim 11 by glue or high frequency hot-melting process.

The fastener channels of the reinforcing sleeves 21 are coaxially aligned with the fastening through holes 114 at the inner wall 111 when the reinforcing sleeves 21 are embedded in the surrounding rim 11. Accordingly, a fastener 22 is fastened at the reinforcing sleeve 21 to couple the runner 30 at the surrounding rim 11 of the reinforcing tabletop panel 10. In particular, the fastener 22 is rotatably engaged with the fastener channel of the reinforcing sleeve 21 through the fastening through hole 114 of the inner wall 111 and the runner through slot 31 of the runner 30, as shown in FIG. 3.

The method for manufacturing the banquet table comprises the following steps.

(1) Manufacture the reinforcing tabletop frame by the following steps.

(1.1) Mold-inject a raw material in a tabletop mold to form the reinforcing tabletop panel 10 having two surrounding rims 11 extended along two longitudinal sides of the reinforcing tabletop panel 10 respectively. Accordingly, the reinforcing tabletop panel 10 is made by the mold-injection process, i.e. the blow mold injection process. During the mold-injection process, the inner wall 111, the outer wall 112, and the bottom wall 113 are formed at the surrounding rim 11 of the reinforcing tabletop panel 10. In addition, the fastening through holes 114 are spacedly formed at the inner wall 111 during the mold-injection process.

(1.2) Spacedly embed the reinforcing arrangements 20 in the surrounding rims 11 of the reinforcing tabletop panel 10 respectively during the mold-injection process. Accordingly, the reinforcing sleeves 21 are disposed in the tabletop mold, wherein during the mold-injection process, the reinforcing sleeves 21 are embedded between the inner and outer walls 111, 112 of each of the surrounding rims 11. In other words, the reinforcing sleeves 21 are pre-installed and built-in with the reinforcing tabletop panel 10 to form the reinforcing tabletop frame.

(2) Attach two runners 30 along the surrounding rims 11 the reinforcing tabletop panel 10 via the reinforcing arrangements 20. Accordingly, the fasteners 22 are rotatably engaged with the fastener channels of the reinforcing sleeves 21 through the fastening through holes 114 of the inner walls 111 and the runner through slots 31 of the runners 30, so as to attach the runners 30 at the surrounding rims 11 of the reinforcing tabletop panel 10.

(3) Pivotally attach two leg frames 40 at the bottom side of the reinforcing tabletop panel 10. Accordingly, each of the leg frames 40 is pivotally coupled between the runners 30 in order to pivotally fold between the folded position and the unfolded position.

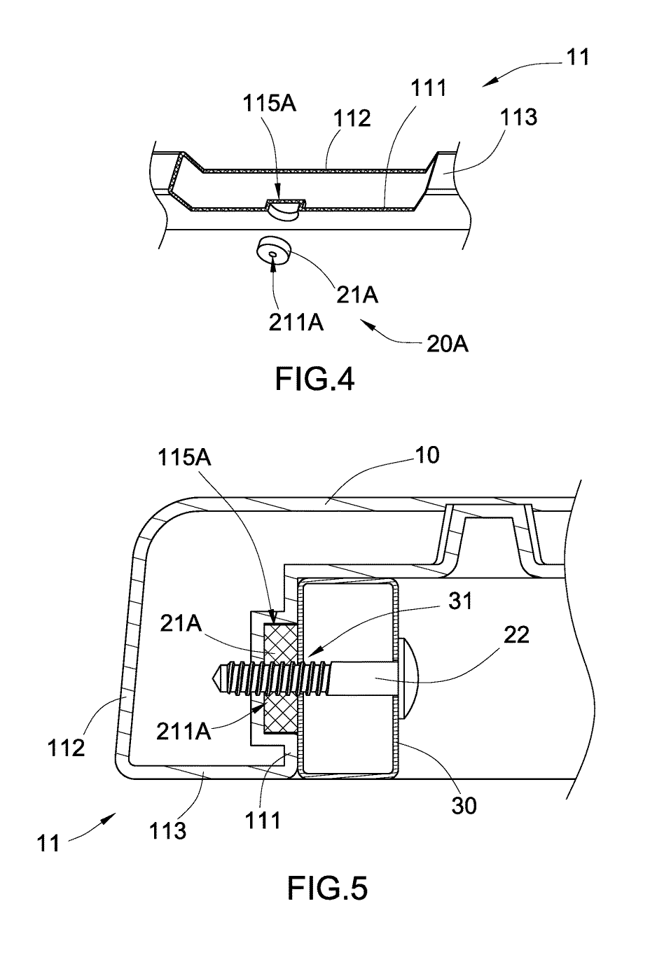

FIGS. 4 and 5 illustrate a first alternative mode of the reinforcing arrangements 20A. Accordingly, each of the reinforcing arrangements 20A comprises an annular reinforcing disc 21A embedded at the surrounding rim 11 of the reinforcing tabletop panel 10. Preferably, the reinforcing discs 21A are spacedly embedded at the inner side of the surrounding rim 11 of the reinforcing tabletop panel 10. Each of the reinforcing discs 21A has a fastening hole 211A, wherein the fastener 22 is fastened at the reinforcing disc 21A through the fastening hole 211A thereof to couple the runner 30 at the surrounding rim 11 of the reinforcing tabletop panel 10.

As shown in FIG. 4, each of the surrounding rims 11 has a fastener cavity 115A indented thereat that the reinforcing disc 21A is embedded in the surrounding rim 11 at the fastener cavity 115A. Preferably, the reinforcing disc 21A is made of rigid material, such as metal, different from the reinforcing tabletop panel 10. It is worth mentioning that the reinforcing disc 21A can be coupled at the surrounding rim 11 by glue or high frequency hot-melting process. A depth of the fastener cavity 115A is not larger than, preferably equal to, a thickness of the reinforcing disc 21A, such that when the reinforcing disc 21A is disposed in the fastener cavity 115A, a surface of the reinforcing disc 21A is aligned with the inner wall 111 of the surrounding rim 11. Therefore, the reinforcing disc 21A will not protruded from the inner wall 111 of the surrounding rim 11.

In particular, the fastener cavities 115A are spacedly indented at the inner wall 111 of each of the surrounding rims 11, wherein when the reinforcing discs 21A are embedded in the fastener cavities 115A of the surrounding rim 11, the fastening holes 211A of the reinforcing discs 21A are aligned with the runner through slots 31 of the runner 30 respectively. Therefore, when the fastener 22 is fastened at the fastening hole 211A of the reinforcing disc 21A, a free end of the fastener 22 is extended through the inner wall 111 of the surrounding rim 11 in order to couple the runner 30 at the surrounding rim 11 of the reinforcing tabletop panel 10, as shown in FIG. 5.

Accordingly, the reinforcing discs 21A are disposed in the tabletop mold, wherein during the mold-injection process, the reinforcing discs 21A are embedded at fastener cavities 115A of the inner wall 111 of each of the surrounding rims 11. In other words, the reinforcing discs 21A are pre-installed and built-in with the reinforcing tabletop panel 10 to form the reinforcing tabletop frame.

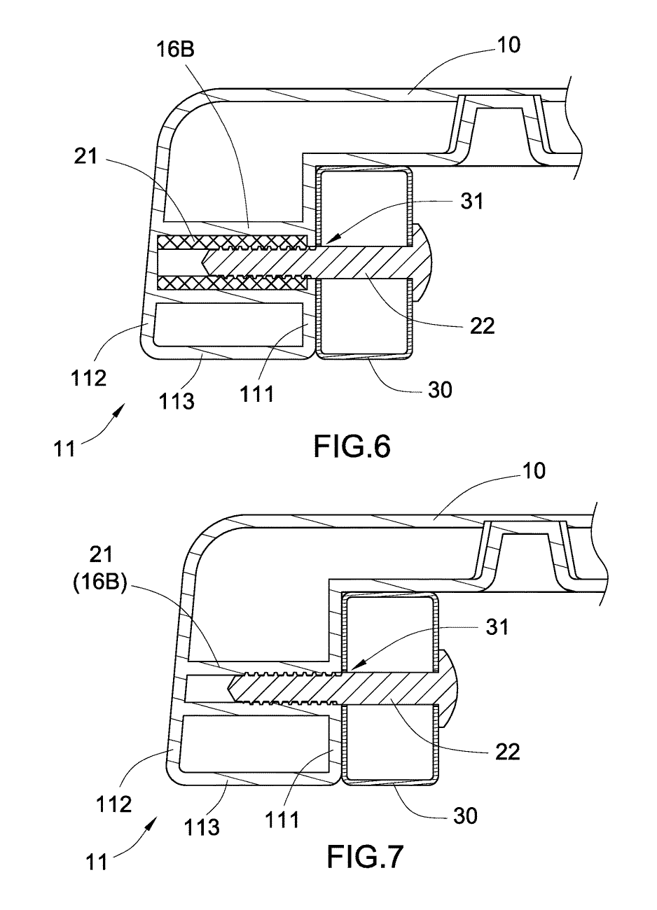

FIG. 6 illustrates a second alternative mode of the reinforcing tabletop frame which has the similar structural configuration of the preferred embodiment, wherein the two ends of the reinforcing sleeve 21 are embedded in two inner sides of the inner and outer walls 111, 112 of the surrounding rim 11, such that the reinforcing sleeve 21 is securely retained at the surrounding rim 11 between the inner and outer walls 111, 112 thereof.

As shown in FIG. 6, the reinforcing tabletop panel 10 further comprises a tubular receiving member 16B integrally extended between the inner and outer walls 111, 112, wherein the reinforcing sleeve 21 is coaxially received in the receiving member 16B. Accordingly, the receiving member 16B is integrally formed between the inner and outer walls 111, 112 during the mold-injection process, wherein the receiving member 16B has one closed end formed at the outer wall 112 of the surrounding rim 11 and an opened end formed at the inner wall 111 of the surrounding rim 11. Therefore, the reinforcing sleeve 21 is embedded between the inner and outer walls 111, 112 and is encircled within the receiving member 16B.

Therefore, the fastener 22 is rotatably engaged with the fastener channel of the reinforcing sleeve 21 through the fastening through hole 114 of the inner wall 111 and the runner through slot 31 of the runner 30.

FIG. 7 illustrates a third alternative mode of the reinforcing tabletop frame, wherein the reinforcing sleeve 21 is integrally formed with the receiving member 16B. In other words, the reinforcing sleeve 21 is made of the material same as the reinforcing tabletop panel 10. Accordingly, the reinforcing sleeve 21 is integrally formed between the inner and outer walls 111, 112 during the mold-injection process.

According to the preferred embodiment, the reinforcing tabletop frame can be incorporated with different supporting frames. For example, the reinforcing tabletop panel 10 can be configured to have a first table panel and a second table panel identical to the first table panel, as shown in FIG. 1, wherein the reinforcing arrangements 20 are pre-installed and built-in with each of the first and second table panels. Each of the runners 30 comprises two runner arms pivotally coupled with each other end-to-end via a pivot hinge, wherein the two runner arms of each of the runners 30 are coupled at each surrounding rim 11 of the reinforcing tabletop panel 10 at a position that the two runner arms are coupled at the first and second table panels respectively via the reinforcing arrangements 20. Therefore, the reinforcing tabletop panel 10 can be overlapped folded in half via the pivot hinges. In addition different types of leg frames 40 can also be coupled at the bottom side of the reinforcing tabletop panel 10 via the runners 30.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A banquet table, comprising:
a reinforcing tabletop frame comprising a reinforcing tabletop panel, which is made of mold-injected material, having two surrounding rims extended along two longitudinal sides of said reinforcing tabletop panel respectively, and a plurality of reinforcing arrangements spacedly embedded in said surrounding rims of said reinforcing tabletop panel respectively; and
a supporting frame comprising two runners attached along said surrounding rims of said reinforcing tabletop panel via said reinforcing arrangements, and two leg frame pivotally attached at a bottom side of said reinforcing tabletop panel.

2. The banquet table, as recited in claim 1, wherein each of said reinforcing arrangements comprises a tubular reinforcing sleeve embedded at said surrounding rim of said reinforcing tabletop panel and a fastener fastened at said reinforcing sleeve to couple said runner at said surrounding rim of said reinforcing tabletop panel.

3. The banquet table, as recited in claim 2, wherein each of said surrounding rims comprises an inner wall aligned with said runner and an outer wall spacedly extended from said inner wall, wherein two ends of said reinforcing sleeve are embedded in two inner sides of said inner and outer walls of said surrounding rim.

4. The banquet table, as recited in claim 3, wherein said inner wall of said surrounding rim has a fastening through hole aligned with said reinforcing sleeve, such that said fastener is fastened with said reinforcing sleeve through said fastening through hole.

5. The banquet table, as recited in claim 3, wherein said reinforcing tabletop panel further comprises a tubular receiving member integrally extended between said inner and outer walls, wherein said reinforcing sleeve is coaxially received in said receiving member.

6. The banquet table, as recited 5, wherein said reinforcing sleeve is integrally formed with said receiving member.

7. The banquet table, as recited in claim 1, wherein each of said reinforcing arrangements comprises an annular reinforcing disc embedded at said surrounding rim of said reinforcing tabletop panel and a fastener fastened at said reinforcing disc to couple said runner at said surrounding rim of said reinforcing tabletop panel.

8. The banquet table, as recited in claim 7, wherein each of said surrounding rims has a fastener cavity indented thereat that said reinforcing disc is embedded in said surrounding rim at said fastener cavity.

9. The banquet table, as recited in claim 8, wherein said reinforcing disc has a fastening hole that said fastener is fastened at said reinforcing disc through said fastening hole to affix to said surrounding rim so as to couple said runner at said surrounding rim of said reinforcing tabletop panel.

10. The banquet table, as recited in claim 1, wherein said reinforcing sleeve is made of metal.

11. A method of manufacturing a banquet table, comprising the steps of:
(a) manufacturing a reinforcing tabletop frame by the steps of:
(a.1) mold-injecting a raw material in a tabletop mold to form a reinforcing tabletop panel having two surrounding rims extended along two longitudinal sides of said reinforcing tabletop panel respectively; and
(a.2) spacedly embedding a plurality of reinforcing arrangements in said surrounding rims of said reinforcing tabletop panel respectively during mold-injection process;
(b) attaching two runners along said surrounding rims of said reinforcing tabletop panel via said reinforcing arrangements; and
(c) pivotally attaching two leg frames at a bottom side of said reinforcing tabletop panel.

12. The method, as recited in claim 11, wherein the step (a.2) further comprises a step of spacedly disposing a plurality of tubular reinforcing sleeves of said reinforcing arrangements in said tabletop mold, such that said reinforcing sleeves are embedded at said surrounding rims of said reinforcing tabletop panel when said raw material is injected into said tabletop mold.

13. The method, as recited in claim 12, wherein the step (a.2) further comprises a step of forming an inner wall and an outer wall of each of said surrounding rims of said reinforcing tabletop panel, such that two ends of said reinforcing sleeve are embedded in two inner sides of said inner and outer walls of said surrounding rim.

14. The method, as recited in claim 13, wherein the step (a.2) further comprises a step of integrally forming a tubular receiving member between said inner and outer walls, wherein said reinforcing sleeve is coaxially received in said receiving member.

15. The method, as recited in claim 14, wherein said reinforcing sleeve is integrally formed with said receiving member.

16. The method, as recited in claim 11, wherein the step (a.2) further comprises a step of spacedly disposing a plurality of annular reinforcing discs of said reinforcing arrangements in said tabletop mold, such that said reinforcing discs are embedded at said surrounding rims of said reinforcing tabletop panel when said raw material is injected into said tabletop mold.

17. The method, as recited in claim 16, wherein the step (a.2) further comprises a step of forming a fastener cavity at each of said surrounding rims of said reinforcing tabletop panel, such that said reinforcing disc is embedded in said surrounding rim at said fastener cavity.

18. A reinforcing tabletop frame for a banquet table which comprises two runners and two leg frames, comprising:
a reinforcing tabletop panel, which is made of mold-injected material, having two surrounding rims extended along two longitudinal sides of said reinforcing tabletop panel respectively, wherein said reinforcing tabletop panel has a bottom side adapted for pivotally coupling with the leg frames; and
a plurality of reinforcing arrangements spacedly embedded in said surrounding rims of said reinforcing tabletop panel respectively for attaching the runners along said surrounding rims said reinforcing tabletop panel.

19. The reinforcing tabletop frame, as recited in claim 18, wherein each of said reinforcing arrangements comprises a tubular reinforcing sleeve embedded at said surrounding rim of said reinforcing tabletop panel for fastening at said reinforcing sleeve via a fastener to couple the runner at said surrounding rim of said reinforcing tabletop panel.

20. The banquet tabletop frame, as recited in claim 19, wherein each of said surrounding rims comprises an inner wall aligned with said runner and an outer wall spacedly extended from said inner wall, wherein two ends of said reinforcing sleeve are embedded in two inner sides of said inner and outer walls of said surrounding rim.

21. The banquet tabletop frame, as recited in claim 18, wherein each of said reinforcing arrangements comprises an annular reinforcing disc embedded at said surrounding rim of said reinforcing tabletop for fastening at said reinforcing disc via a fastener to couple said runner at said surrounding rim of said reinforcing tabletop panel.

22. The banquet tabletop frame, as recited in claim 21, wherein each of said surrounding rims has a fastener cavity indented thereat that said reinforcing disc is embedded in said surrounding rim at said fastener cavity.
